(19) United States
(12) Patent Application Publication
(10) Pub. No.: US 2009/0050581 A1
(43) Pub. Date: Feb. 26, 2009

(54) DEVICE AND METHOD FOR PROCESSING BACKFLUSHED FLUID

(75) Inventor: Egon Kaske, Aachen (DE)

Correspondence Address: HANLEY, FLIGHT & ZIMMERMAN, LLC, 150 S. WACKER DRIVE, SUITE 2100, CHICAGO, IL, 60606, US

(73) Assignee: Durr Ecoclean GmbH, Filderstadt (DE)

(21) Appl. No.: 12/205,490

(22) Filed: Sep. 5, 2008

Related U.S. Application Data
(63) Continuation of application No. PCT/EP2007/001570, filed on Feb. 23, 2007.

(30) Foreign Application Priority Data
Mar. 9, 2006 (DE) 10 2006 010 842.6

(51) Int. Cl. B01D 21/24; B01D 29/66

(52) U.S. Cl. 210/797; 210/800; 210/804; 210/533; 210/322; 210/313

(57) ABSTRACT

In order to provide a device for processing backflushed fluid from a backflushing filter containing solids, comprising a sedimentation device for separating solids from the backflushed fluid by sedimentation in a sediment collecting region, which device allows a discharge of solids without auxiliary filter agents, and has a fluid loss which is as low as possible, it is proposed that the sedimentation device should comprise a sluice mechanism, by means of which the sediment collecting region can be connected to a sedimentation container during a sedimentation phase and can be separated from the sedimentation container during a discharge phase and can be emptied.

### RELATED APPLICATION

This application is a continuation application of PCT/EP2007/001570 filed Feb. 23, 2007, the entire specification of which is incorporated herein by reference.

### FIELD OF THE DISCLOSURE

The present invention relates to a device for processing backflushed fluid from a backflushing filter, containing solids, the device comprising a sedimentation device for separating solids from the backflushed fluid by sedimentation in a sediment collecting region.

### BACKGROUND

Devices for processing backflushed fluid from a backflushing filter are known from the prior art, in which the backflushed fluid of the backflushing filter is put into a processing basin or onto a band filter system. Processing devices of this type have a high fluid loss and/or require auxiliary filter aids, such as, for example, filter paper, to discharge the solids contained in the backflushed fluid.

### SUMMARY OF THE INVENTION

The present invention is based on the object of providing a device for processing backflushed fluid from a backflushing filter of the type mentioned at the outset, which allows a discharge of solids without auxiliary filtering aids and has a fluid loss which is as low as possible.

This object is achieved according to the invention in a device with the features of the preamble of claim 1 in that the sedimentation device comprises a sluice mechanism, by means of which the sedimentation region can be connected to a sedimentation container during a sedimentation phase and can be separated from the sedimentation container during a discharge phase and can be emptied.

The sedimented solids fraction can thus be separated from the backflushed fluid by the sluice mechanism provided according to the invention and can be discharged without auxiliary filter aids being required for this.

Furthermore, the amount of fluid discharged together with the solids fraction can be reduced by the separation of the sediment collecting region from the sedimentation container during the discharge phase by means of the sluice mechanism.

The amount of fluid discharged together with the solids fraction is particularly small if the discharge phase is initiated when the sediment collecting region is filled with sedimented solid as completely as possible.

The device according to the invention for processing flushed fluid is suitable, in particular, for use in cleaning systems with aqueous cleaners, oils and/or emulsions.

In a preferred configuration of the device according to the invention, it is provided that the sluice mechanism comprises a check valve arranged between the sedimentation container and the sediment collecting region.

It may furthermore be provided that the sluice mechanism comprises a check valve arranged between the sediment collecting region and a sediment outlet.

In order to further reduce the amount of residual fluid contained in the separated solids fraction, it may be provided that the processing device comprises a solids separator, to which the sediment discharged from the sediment collecting region can be supplied.

In order to be able to further utilise the residual fluid separated from the solids fraction of the sediment by means of the solids separator and therefore further reduce the fluid consumption of the filter device comprising the backflushing filter, it is favourable if the device comprises a return line, through which residual fluid separated by means of the solids separator can be supplied to a container for fluid medium to be supplied to the backflushing filter.

The backflushed fluid from the backflushing filter, containing solids, is separated by means of the sedimentation device into a sediment and clear phase.

In order to further utilise the fluid forming the clear phase and to reduce the fluid consumption of a filter device comprising the backflushing filter, it is favourable if the device comprises a clear phase line, through which clear phase can be supplied from the sedimentation container to a container for fluid medium to be supplied to the backflushing filter.

As an alternative or in addition to this, it may also be provided that the device comprises a clear phase line, by means of which clear phase from the sedimentation container can be supplied to a container for filtrate from the backflushing filter.

In a preferred configuration of the invention it is provided that the sedimentation device comprises a compressed air supply, by means of which the interior of the sedimentation container can be acted upon by air at raised pressure.

In particular, it may be provided that clear phase can be removed from the interior of the sedimentation container by the raised pressure, in order, in this manner, to discharge the clear phase from the sedimentation container.

It may furthermore be provided that the sedimentation container is provided with an air cushion chamber, which contains an air cushion which can be compressed by the supply of compressed air to the sedimentation container.

An air cushion chamber of this type may, in particular, be bounded by one or more tubes.

In order to prevent contaminants from the sedimentation container also being discharged together with the clear phase, the sedimentation device may comprise a screen, through which clear phase can be removed from the sedimentation container.

In a preferred configuration of the invention it is provided that the screen can be flushed free of contaminants by means of an air cushion.

In particular, this may be an air cushion which can be compressed by the supply of compressed air to the sedimentation container.

The expansion of the air cushion, by means of which the screen is flushed free, can be assisted in the process by an external compressed air supply to the air cushion.

The present invention is based on the further object of providing a method for processing backflushed fluid from a backflushing filter, containing solids, which allows solids to be discharged without auxiliary filter aids, with a fluid loss which is as low as possible.

This object is achieved according to the invention by a method for processing backflushed fluid from a backflushing filter, containing solids, the method comprising the following method steps:
connecting a sediment collecting region to a sedimentation container by means of a sluice mechanism;
sedimenting solids from the backflushed fluid in the sediment collecting region; and
separating the sediment collecting region from the sedimentation container and emptying the sediment collecting region by means of the sluice mechanism.

Since the sediment collecting region is separated from the sedimentation container before the discharge of the sediment by means of the sluice mechanism, discharge of the sedimented solids, without auxiliary filter aids, is achieved and the amount of residual fluid, which is discharged together with the sedimented solid, is reduced.

Particular configurations of the method according to the invention are the subject of the dependent claims 15 to 25, the advantages of which have already been described above in conjunction with the preferred configurations of the device according to the invention.

Further features and advantages of the invention are the subject of the following description and the graphical view of an embodiment.

### BRIEF DESCRIPTION OF THE DRAWINGS

FIG. 1 shows a schematic view of a filter device for filtering a fluid medium containing solids;

FIG. 2 shows a partially sectional side view of a backflushing filter with a coarse dirt outlet and a flushing line of the filter device from FIG. 1, during a filtering phase of the backflushing filter;

FIG. 3 shows a view of the backflushing filter corresponding to FIG. 2 with the coarse dirt outlet and the flushing line during a backflushing phase of the backflushing filter;

FIG. 4 shows a schematic, partially sectional side view of a sedimentation device of the filter device from FIG. 1 in a sedimentation phase of the sedimentation device;

FIG. 5 shows a view of the sedimentation device corresponding to FIG. 4 in a sediment and clear phase discharge phase of the sedimentation device;

FIG. 6 shows a view of the sedimentation device corresponding to FIG. 5, at the end of the clear phase discharge phase of the sedimentation device; and

FIG. 7 shows a view of the sedimentation device corresponding to FIG. 6, in a screen flushing phase of the sedimentation device.

The same or functionally equivalent elements are designated by the same reference numerals in all the figures.

### DETAILED DESCRIPTION OF THE INVENTION

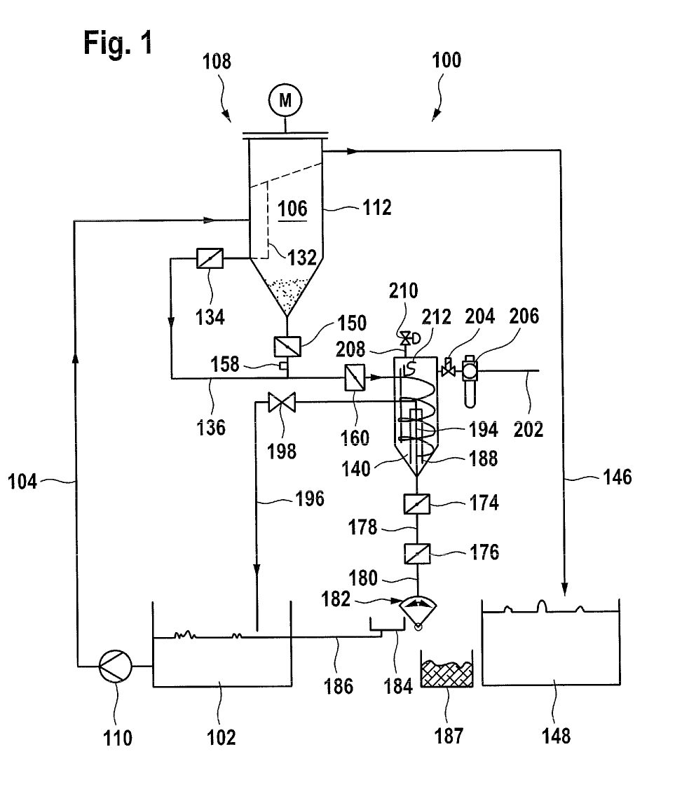

A filter device designated as a whole by 100 and shown in FIG. 1 to 7 for filtering a fluid medium containing solids, for example an aqueous cleaner, an oil or an emulsion, comprises a dirt tank 102 for receiving the medium to be filtered, which is connected to a dirt-side compartment 106 of a backflushing filter 108 by means of a filter supply line 104.

A filter pump 110 for conveying the medium to be filtered from the dirt tank 102 to the backflushing filter 108 is arranged in the filter supply line 104.

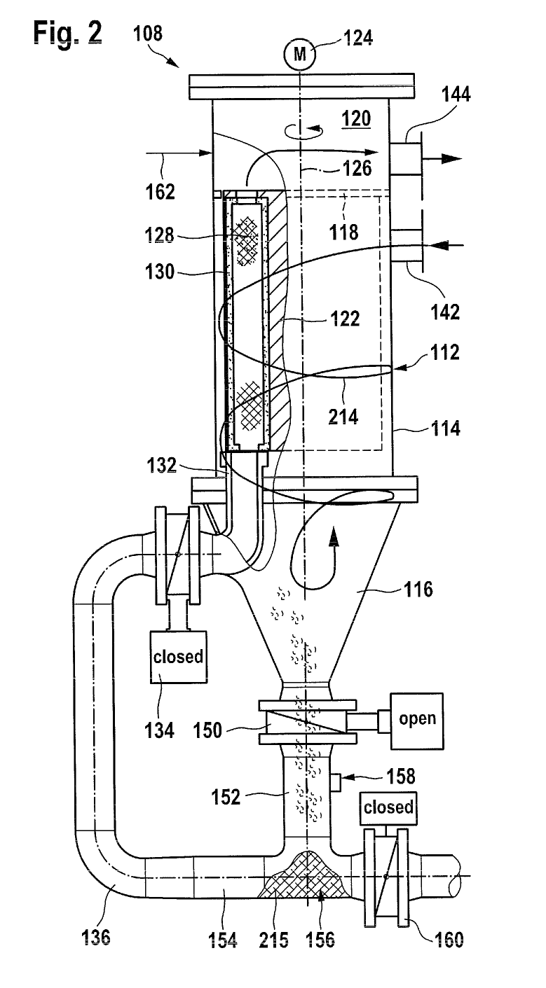

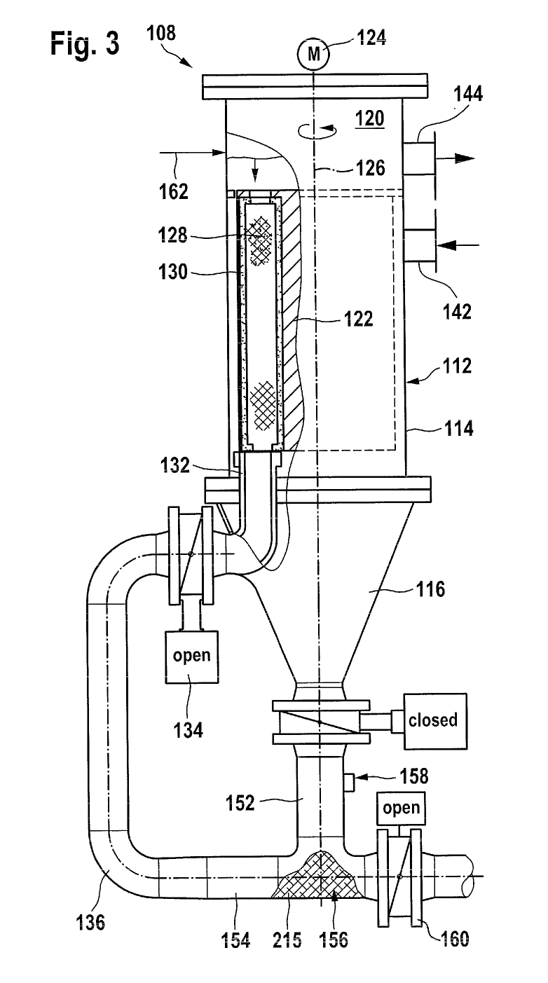

The structure of the backflushing filter 108 can be seen in detail from FIGS. 2 and 3.

The backflushing filter 108 comprises a filter housing 112 with a substantially cylindrical upper portion 114 and a lower portion 116, which tapers conically downwardly, adjoining the bottom of the upper portion 114.

The upper portion 114 of the filter housing 112 is separated by a horizontal partition 118 into a filtrate-side compartment 120 located above the partition 118 and the dirt-side compartment 106 located below the partition 118, the interior of the lower portion 116 of the filter housing 112 also being included with the dirt-side compartment 106 of the backflushing filter 108.

A filter insert 122 is also arranged in the filter housing 112 and can be rotated by means of a motor 124 about a vertical axis 126 of a rotation and contains a plurality of filter elements 128, which, by rotating the filter insert 122 about the axis 126 of rotation, can be moved one after the other into a filter chamber 130 of the backflushing filter 108.

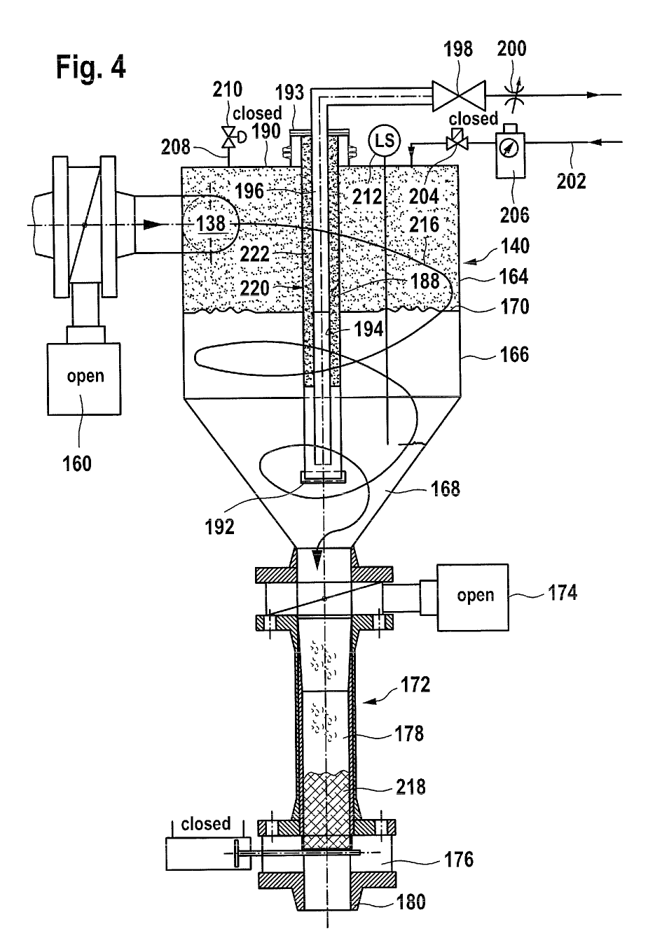

On the filtrate side, the filter chamber element 128 respectively located in the filter chamber 130 is, on the one hand, connected to the filtrate-side chamber 120 of the filter housing 112 and, on the other hand, to a backflushing line 132, which leads from the filter chamber 130 to a backflushing valve 134. The backflushing valve 134 is furthermore connected to a flushing line 136 which leads from the backflushing filter 108 to a fluid inlet 138 (see FIG. 4) of a sedimentation container 140.

A dirt-side feed 142, opening into the dirt-side compartment 106 of the filter housing 112, of the backflushing filter 108 is connected to the filter supply line 104.

A filtrate-side return 144 opening into the filtrate-side compartment 120 of the filter housing 112, of the backflushing filter 108 is connected by means of a filter return line 146 (see FIG. 1) to a clean tank 148 to receive the filtered medium.

Furthermore, a compressed air supply 162, which is connected to a compressed air source (not shown), opens into the filtrate-side compartment 120 of the filter housing 112.

The conically tapering lower portion 116 of the filter housing 112 can be connected at its lower end by means of a coarse dirt valve 150.

The coarse dirt valve 150 is furthermore connected to the flushing line 136 by means of a vertically extending coarse dirt line 152, the coarse dirt line 152 being used as a coarse dirt outlet opening at its lower end into a substantially horizontally extending portion 154 of the flushing line 136, so a coarse dirt collecting chamber 156 is formed in the flushing line 136 in the region of the mouth of the coarse dirt line 152.

A metal sensor 158 to detect the filling level of the coarse dirt in the coarse dirt line 152 is arranged on the coarse dirt line 152.

Arranged downstream of the coarse dirt collecting chamber 156 in the flushing line 136 is a backflushing discharge valve 160, by means of which the access to the sedimentation container 140 shown in detail in FIG. 4 to 7 can be blocked.

The sedimentation container 140 comprises a container housing 164 with a substantially cylindrical upper portion 166 and a lower portion 168 tapering conically downwardly and adjoining the bottom of the upper portion 166.

The flushing line 136 opens into the upper portion 166 of the container housing 164 by means of the fluid inlet 138, specifically above a fluid level 170 in the sedimentation container 140.

The lower end of the conically tapering portion 168 of the sedimentation container 140 opens into a sluice device designated as a whole 172, which comprises an upper sluice valve 174 adjoining the sedimentation container 140, a lower sluice valve 176 forming a lower termination of the sluice device 172 and a sluice chamber 178 arranged between the upper sluice valve 174 and the lower sluice valve 176, the inner chamber of which sluice chamber forms a sediment collecting region.

The lower sluice valve 176 may be formed as a slide valve, in particular.

The lower sluice valve 176 is furthermore connected by means of a sediment discharge line 180 to an inlet of a solids separator 182 (see FIG. 1).

The solids separator 182 is used to separate the remaining fluid medium containing sediment coming from the sluice chamber 178 from the solids portion of the sediment.

The solids separator 182 may, in particular, be constructed and function in the manner of the magnetic solids separator described in WO 2004/041438 A1. Reference is expressly made here to WO 2004/041438 A1 in relation to the structure and the mode of functioning of a solids separator of this type.

A residual fluid return line 186 leads from a fluid outlet 184 of the solids separator 182 to the dirt tank 102.

The solids fraction of the sediment from the sluice chamber 178 separated from the residual fluid in the fluids separator 182 arrives in a solids collecting container 187.

Furthermore, arranged substantially centrally in the sedimentation container 140 is a flushing tube 188 which extends along a substantially vertical tube axis through a lid 190 of the sedimentation container 140 into the interior thereof into the lower portion 168 of the container housing 164 and opens there into the inner chamber of the sedimentation container 140 at a point located below the fluid level 170.

The mouth of the flushing tube 188 is closed by a screen 192 at the lower end thereof.

The upper end of the flushing tube 188 is closed by a sealing plate 193.

A starting portion 194 arranged coaxially with respect to the flushing tube 188, of a clear phase return line 196, which passes through the sealing plate 193 and leads from the sedimentation container 140 to the dirt tank 102, extends inside the flushing tube 188 (see FIG. 1).

A check valve 198 and a through-flow regulator 200 are arranged in the clear phase return line 196.

A compressed air supply line 202, in which a compressed air valve 204 and a pressure regulator 206 are arranged, furthermore opens into the part of the interior of the sedimentation container 140 located above the fluid level 170.

The compressed air supply line 202 is connected to a compressed air source (not shown).

Furthermore, a ventilation line 208, in which a ventilation valve 210 is arranged, opens into the part of the interior of the sedimentation container 140 located above the fluid level 170, so that the interior of the sedimentation container 140 can be ventilated with ambient air when the ventilation valve 210 is open.

Furthermore, the sedimentation container 140 is provided with a level probe 212 to detect the fluid level 170 inside the sedimentation container 140.

The filter device 100 described below functions as follows:

The fluid medium mixed with solids to be filtered off, for example an aqueous cleaning fluid, oil or emulsion, is collected in the dirt tank 102.

The medium to be filtered is supplied from the dirt tank 102 by means of the filter pump 110 to the dirt-side compartment 106 of the backflushing filter 108.

As can be seen from FIG. 2, the supply 142 of the backflushing filter 108 runs substantially tangentially to the inner boundary wall of the filter housing 112, so the medium to be filtered moves in a helical path 214 through the interior of the filter housing 112.

On entry of the medium to be filtered into the backflushing filter 108, heavy dirt particles sink downward through the opened coarse dirt valve 150 and the coarse dirt line 152 into the coarse dirt collecting chamber 156 in the flushing line 136, where a coarse dirt accumulation 215 forms as a result during the filtering phase of the backflushing filter 108 (see FIG. 2).

During this filtering phase of the backflushing filter 108 shown in FIG. 2, the backflushing valve 134 and the backflushing discharge valve 160 are closed.

The medium to be filtered is supplied from the dirt-side chamber 106 of the backflushing filter 108 through the filter element 128 located in the filter chamber 130 to the filtrate-side chamber 120 of the backflushing filter 108.

The filtrate arrives from the filtrate-side chamber 120 of the backflushing filter 108 by means of the filter return line 146 into the clean tank 148.

When passing through the filter element 128, the finer solids particles are held back between the dirt side and the clean side of the filter element 128 according to the filter fineness of the filter element 128.

When the maximum dirt receiving capacity of the filter element 128 is reached, a backflushing phase of the backflushing filter 108 shown in FIG. 3 is initiated to regenerate the filter element 128, i.e. a compressed air-assisted backflushing of the filter medium from the clean side to the dirt side.

The coarse dirt valve 150 is closed for this backflushing process, and the backflushing discharge valve 160 in the flushing line 136 is opened.

The check valve 134 is then briefly opened, and the filtrate side chamber 120 of the flushing filter 108 is acted upon by compressed air by means of the compressed air supply 162, so that filtrate is flushed from the filtrate-side compartment 120 of the backflushing filter 108, assisted by compressed air, by the filter medium of the filter element 128 back into the dirt-side chamber 106 of the backflushing filter 108, from there into the backflushing line 132 and from there through the opened backflushing valve 134 into the flushing line 136.

Together with the filtrate to be used as the flushing medium, the contaminants detached from the filter element 128 during the backflushing also arrive in the flushing line 136.

The backflushed fluid also arrives through the coarse dirt collecting chamber 156 and flushes the coarse dirt accumulated there through the opened backflushing discharge valve 160 into the sedimentation container 140.

The backflushing discharge valve 160 is open for a period of about 1 s to 3 s, for example, during each backflushing phase.

The backflushing phase of the backflushing filter 108 is ended by closing the backflushing valve 134 and the backflushing discharge valve 160 and reopening of the coarse dirt valve 150, whereupon a new filtering phase of the backflushing filter 108 begins.

The backflushing phase of the backflushing filter 108 can be initiated if a predetermined maximum filling level of the coarse dirt in the coarse dirt line 152 is detected by means of the metal sensor 158 on the coarse dirt line 152.

As an alternative or additionally to this, a backflushing phase of the backflushing filter 108 can be initiated if the differential pressure between the dirt side and the clean side of the filter element 128 exceeds a predetermined maximum value.

The processing of the fluid backflushed in the backflushing phase takes place in the sedimentation container 140 shown in FIG. 4 to 7.

As can be seen from FIG. 4, the fluid inlet 138 is oriented substantially tangentially to the inner wall of the container housing 164, so that the backflushed fluid enters the interior of the sedimentation container 140 in a helical path 216.

The solids contained in the backflushed fluid (coarse dirt and contaminants backflushed from the filter element 128) are sedimented in the sedimentation container 140 and arrive through the opened upper sluice valve 174 into the sluice chamber 178, which is closed at the bottom by the closed lower sluice valve 176.

A sediment collection 218 forms in the sluice chamber 178.

Thus, the sedimentation container 140 and the sluice mechanism 172 together form a sedimentation device of the filter device 100.

During this sedimentation phase shown in FIG. 4, the check valve 198 in the clear phase return line 196, the compressed air valve 204 in the compressed air supply line 202 and the ventilation valve 210 in the ventilation line 208 are closed.

The fluid level 170 in the sedimentation container 140 rises during this sedimentation phase owing to the supply of backflushed fluid from the flushing line 136.

After a predetermined sedimentation time has expired, the upper sluice valve 174 is closed.

The interior of the sedimentation container 140 is then acted upon in a controlled manner by compressed air with an excess pressure of, for example, about 0.3 bar, by opening the compressed air valve 204.

Furthermore, the check valve 198 is opened in the clear phase return line 196, so that the solids-free fluid (clear phase) contained in the interior of the sedimentation container 140 is forced through the screen 192 at the lower end of the flushing tube 188 into the clear phase return line 196 and returned by means of the clear phase return line 196 into the dirt tank 102.

In the process, the clear phase level also rises in the air cushion chamber 220, which is bounded outwardly by the flushing tube 188 and inwardly by the starting portion 194 of the clear phase return line 196, so the air cushion 222 filling the upper region of the air cushion chamber 220 is compressed until the excess pressure of, for example, about 0.3 bar is reached, at which the compressed air is supplied to the interior of the sedimentation container 140.

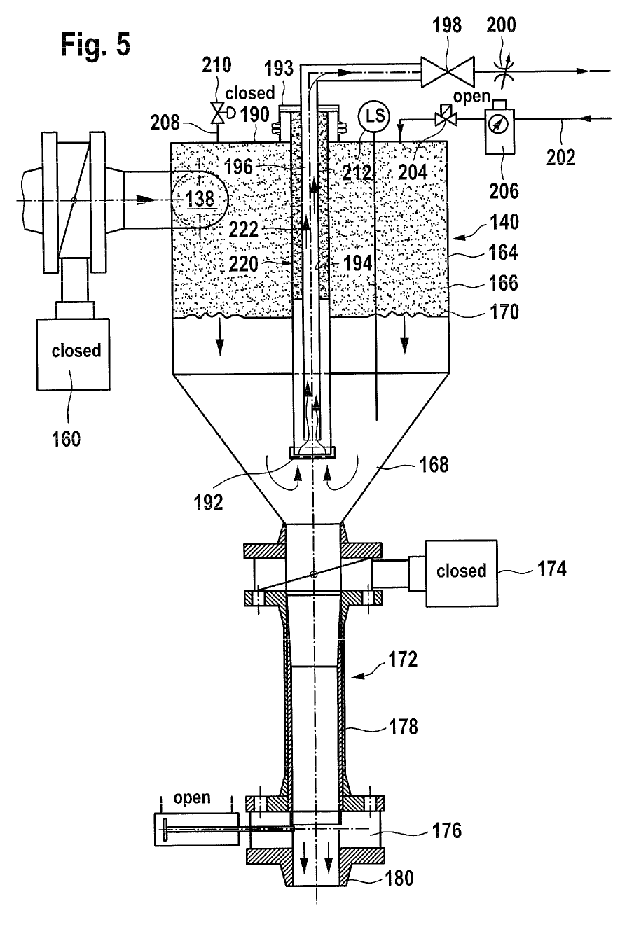

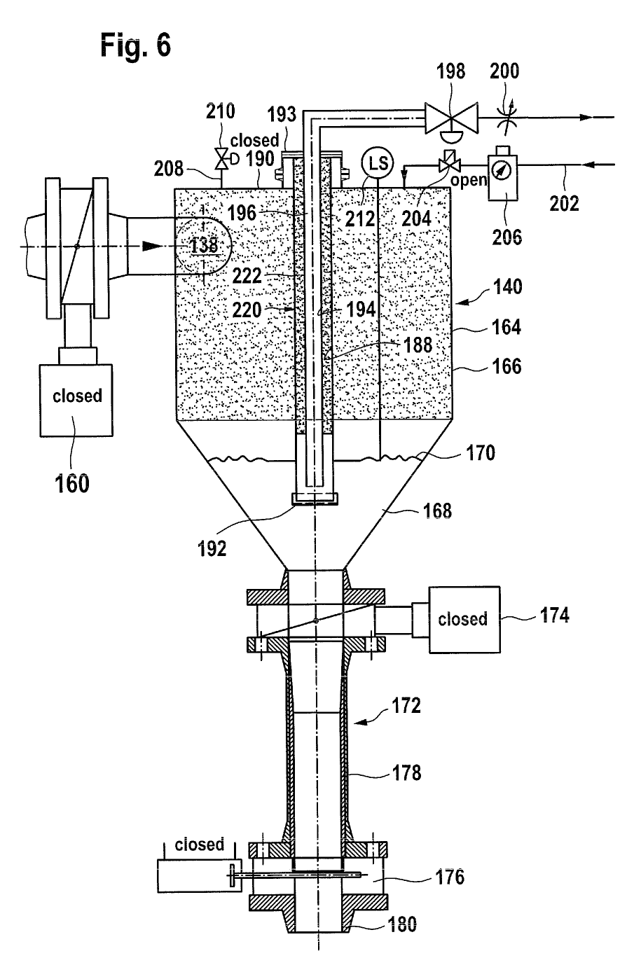

During this clear phase discharge phase, the beginning of which is shown in FIG. 5 and the end of which is shown in FIG. 6, the fluid level 170 drops in the sedimentation container 140 until the predetermined minimum level shown in FIG. 6 is reached, which is detected by means of the level probe 212.

During this clear phase discharge phase, the sluice chamber 178 is emptied by opening the lower sluice valve 176, so that the sediment which has accumulated in the sluice chamber 178 and which contains a solids fraction and residual fluid, arrives through the sedimentation discharge line 180 into the solids separator 182.

After emptying the sluice chamber 178, the lower sluice valve 176 is closed again (see FIG. 6).

The solids fraction of the sediment is separated from the residual fluid in the solids separator 182. The residual fluid is supplied to the dirt tank 102 by means of the residual fluid return line 186. The solids content is supplied to the solids collection container 187 and supplied from there for further treatment or disposal.

On reaching the minimum fluid level 170 in the sedimentation container 140, the compressed air valve 204 in the compressed air supply line 202 and the check valve 198 in the clear phase return line 196 are closed.

The ventilation valve 210 and the upper sluice valve 174 are then opened simultaneously, so the fluid column in the lower region of the air cushion chamber 220 is abruptly relieved of pressure.

The compressed air cushion 222 present in the upper region of the air cushion chamber 220 therefore abruptly expands downward, so the fluid located in the lower region of the flushing tube 188 is forced through the screen 192 into the lower portion 168 of the container housing 164 and in the process detaches contaminants which have accumulated on the screen 192 from the screen 192 and entrains them.

The contaminants thus detached from the screen 192 drop down through the opened upper sluice valve 174 into the sluice chamber 178.

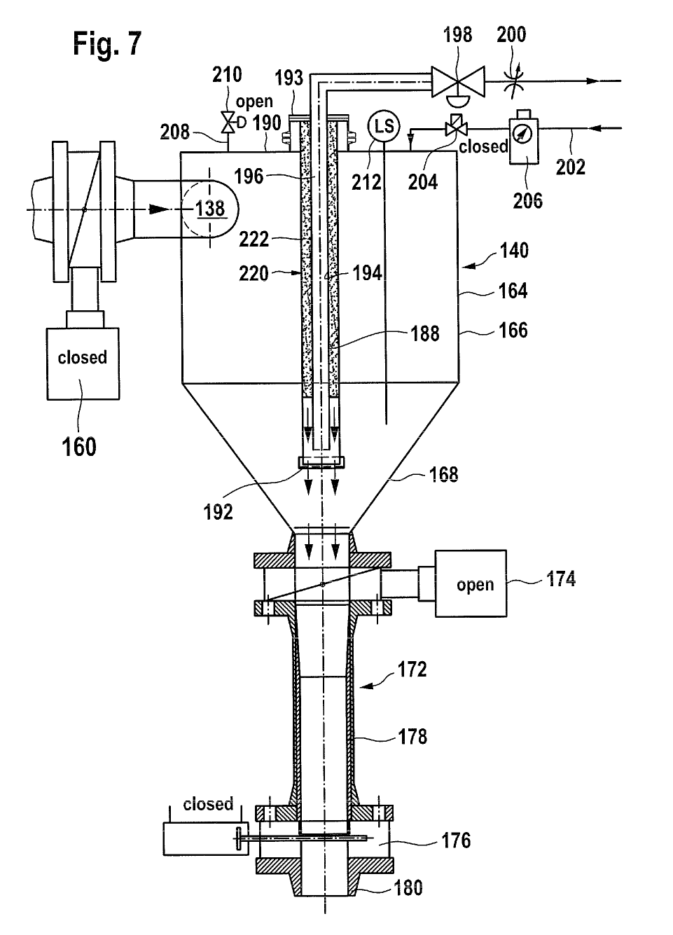

This concludes the screen cleaning phase shown in FIG. 7.

A renewed sedimentation phase of the sedimentation container 140 begins with the next opening of the backflushing discharge valve 160 (see FIG. 4), i.e. with the next backflushing phase of the backflushing filter 108.

In an alternative configuration of the filter device 100 described above, the upper region of the flushing tube 188 is connected to a compressed air supply so the expansion of the air cushion 222 in the screen cleaning phase is assisted by means of externally supplied compressed air.

In an alternative configuration of the above-described filter device 100, the clear phase return line 196 does not lead from the sedimentation container 140 to the dirt tank 102 but to the clean tank 148.

Otherwise, this alternative embodiment of the filter device 100 coincides with regard to structure and function with the above-described filter device 100.

1. Device for processing backflushed fluid from a backflushing filter, which contains solids, comprising a sedimentation device for separating solids from the backflushed fluid by sedimentation in a sediment collecting region, wherein the sedimentation device comprises a sluice mechanism, by means of which the sediment collecting region can be connected to a sedimentation container during a sedimentation phase and can be separated from the sedimentation container and can be emptied during a discharge phase.

2. Device according to claim 1, wherein the sluice mechanism comprises a check valve arranged between the sedimentation container and the sediment collecting region.

3. Device according to claim 1, wherein the sluice mechanism comprises a check valve arranged between the sediment collecting region and a sediment outlet.

4. Device according to claim 1, wherein the device comprises a solids separator, to which the sediment discharged from the sediment collecting region can be supplied.

5. Device according to claim 4, wherein the device comprises a return line, by means of which residual fluid separated by means of the solids separator can be supplied to a container for fluid medium to be supplied to the backflushing filter.

6. Device according to claim 1, wherein the device comprises a clear phase line, by means of which clear phase from the sedimentation container can be supplied to a container for fluid medium to be supplied to the backflushing filter.

7. Device according to claim 1, wherein the device comprises a clear phase line, by means of which clear phase can be supplied from the sedimentation container to a container for filtrate from the backflushing filter.

8. Device according to claim 1, wherein the sedimentation device comprises a compressed air supply, by means of which the interior of the sedimentation container can be acted upon by air at raised pressure.

9. Device according to claim 8, wherein clear phase can be removed from the interior of the sedimentation container by the raised pressure.

10. Device according to claim 1, wherein the sedimentation container is provided with an air cushion chamber, which contains an air cushion which can be compressed by the supply of compressed air to the sedimentation container.

11. Device according to claim 10, wherein the air cushion chamber is bounded by one or more tubes.

12. Device according to claim 1, wherein the sedimentation device comprises a screen, through which clear phase can be removed from the sedimentation container.

13. Device according to claim 12, wherein the screen can be flushed free of contaminants by means of an air cushion.

14. Method for processing backflushed fluid from a backflushing filter, which contains solids, comprising the following method steps:
connecting a sediment collecting region to a sedimentation container by means of a sluice mechanism;
sedimenting solids from the backflushed fluid in the sediment collecting region; and
separating the sediment collecting region from the sedimentation container and emptying the sediment collecting region by means of the sluice mechanism.

15. Method according to claim 14, wherein the sediment collecting region is separated from the sedimentation container by a check valve arranged between the sedimentation container and the sediment collecting region.

16. Method according to claim 14, wherein the sediment collecting region is separated from a sediment outlet during a sedimenting phase by a check valve arranged between the sediment collecting region and the sediment outlet.

17. Method according to claim 14, wherein the sediment discharged from the sediment collecting region is supplied to a solids separator.

18. Method according to claim 17, wherein residual fluid separated from the sediment by means of the solids separator is supplied to a container for fluid medium to be supplied to the backflushing filter.

19. Method according to claim 14, wherein clear phase from the sedimentation container is supplied to a container for fluid medium to be supplied to the backflushing filter.

20. Method according to claim 14, wherein clear phase from the sedimentation container is supplied to a container for filtrate from the backflushing filter.

21. Method according to claim 14, wherein the interior of the sedimentation container is acted upon by air at raised pressure.

22. Method according to claim 21, wherein clear phase is removed from the interior of the sedimentation container by means of air at raised pressure.

23. Method according to claim 14, wherein an air cushion arranged in an air cushion chamber is compressed by the supply of compressed air to the sedimentation container.

24. Method according to claim 14, wherein clear phase is removed from the sedimentation container through a screen.

25. Method according to claim 24, wherein the screen is flushed clear of contaminants by means of an air cushion.
